(19) United States
(12) Patent Application Publication
(10) Pub. No.: US 2009/0254480 A1
(43) Pub. Date: Oct. 8, 2009

(54) SYSTEM AND METHOD FOR PREVENTING GIFT FRAUD

(75) Inventors: Bret M. Esslinger, Weston, FL (US); Richard D. Combs, Pompane Beach, FL (US); Steven E. Arthur, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/099,658

(22) Filed: Apr. 8, 2008

(51) Int. Cl. G06Q 40/00; G06K 19/12; G06K 5/00

(52) U.S. Cl. 705/44; 235/493; 235/380

(57) ABSTRACT

A gift card uses a fraud code stored on a magnetic stripe of the card to prevent fraudulent transactions. When the gift card is purchased at a POS terminal at a merchant location, a gift card account number stored on the magnetic stripe is read, and sent to a gift card system. The gift card system activates the card and generates the fraud code and returns it to the POS terminal, where a card encoder writes the fraud code onto the magnetic stripe. When the gift card is used to conduct a transaction, the transaction is permitted only if a valid fraud code is stored on the magnetic stripe.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

Stored value, gift, or other pre-paid debits cards are well-known for providing access to goods and services. For example, gift cards may be purchased from various merchants such as department stores and restaurants. Pre-paid debit cards are also frequently purchased for telephone services. The purchase and usage of pre-paid debit cards has continued to increase in recent years to the point that the sale of pre-paid debit cards today is a multi-billion dollar industry. Pre-paid cards, such as gift cards issued by a merchant, are advantageous to the merchant because customers using them are more likely to shop the merchant and also more likely to spend beyond the initial value of the gift card. Other prepaid cards may be issued by a bank or money transfer office, and may be used like a credit card to make purchases, up to the balance maintained within the card account.

In some cases, pre-paid debit cards are printed and issued with a predetermined value and balance, and typically sold as a retail item. An example of one such a card is a pre-paid gift card which provides an individual with a set dollar amount for the purchase of goods from a particular merchant. In other cases, a gift card may be printed without a predetermined value, but when it is purchased and activated the customer determines the amount of money to be “loaded” onto the card.

Clearinghouse arrangements have been set up to handle gift card accounts on behalf of merchants. For example First Data Corporation provides database services that merchants may access for activating and maintaining gift card accounts. When the card is purchased, the card is electronically read (e.g., by reading a magnetic stripe on the card) by the merchant in order to obtain an account identifier and then to activate the card (and its associated account) at the database. Once activated, the card is used to make purchases (redemptions) by reading the card at the time of purchase and debiting the purchase amount from the account.

Merchants often market gift cards by prominently displaying them (e.g., near a POS terminal or checkout station), so that a customer may see the various cards offered, and then select the one that best meets the needs of that customer. However, these kinds of arrangements have led to fraud. One fraudulent scheme is known as “skimming.” A thief (sometimes a dishonest store employee), will remove cards from display that have not yet been purchased. The cards are taken to an unauthorized card reader where the card data is collected. The card or cards are then returned to the display. The “stolen” card data is then put on counterfeit “blank” cards for subsequent use by the thief. It does not matter that the original, legitimate card has not been activated, since the thief will simply wait until it has been purchased by a customer at the store, and when activated for that customer, the thief then takes the counterfeit card and uses it to deplete the gift card account before the customer (or the person to whom the customer gives the card) has had a chance to use the legitimate card.

While it is known to use printed security codes on credit cards and similar instruments (for example, printed on the back of a card), such codes are present on the card when issued and can be seen by anyone in possession of the card, and thus will not prevent fraudulent schemes such as skimming.

### BRIEF SUMMARY OF THE INVENTION

There is provided, in accordance with embodiments of the present invention, a network/system and method for preventing fraudulent use of a stored value card, by providing a fraud code to be stored on the card when it is activated.

In some embodiments, methods and systems for preventing fraudulent use of a stored value card compromise steps and/or components that include activating the card for use in conducting transactions at a merchant location, storing a fraud code on the card (at a storage medium) when the card is activated at the merchant location, and permitting a transaction to be completed using an activated card only if the fraud code is stored on the card.

In one embodiment, the stored value card is a gift card and the storage medium is a magnetic stripe on the gift card.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing a network for both activating gift cards and then permitting subsequent use of the gift cards to conduct transactions.

FIG. 2 illustrates exemplary data fields on the magnetic stripe of a gift card, according to one embodiment.

FIG. 3 is a flow diagram illustrating the activation of the gift card.

FIG. 4 is a flow diagram illustrating the use of the gift card in conducting a transaction.

### DETAILED DESCRIPTION OF THE INVENTION

There are various embodiments and configurations for implementing the present invention. Generally, embodiments provide systems and methods for preventing fraudulent use of prepaid debit cards, such as gift cards, by storing or writing a fraud or security code on the card after it has been activated for use.

In one embodiment, a gift card is purchased at a POS system or terminal at a merchant location, where a storage medium on the card (in the form of a magnetic stripe), has account information stored thereon. In order to purchase and activate the gift card, the magnetic stripe is read at a card reader at the POS system in order to identify the card and its associated account. When the gift card is activated, a fraud code is written onto the magnetic stripe by a card encoder (writer) at the POS system.

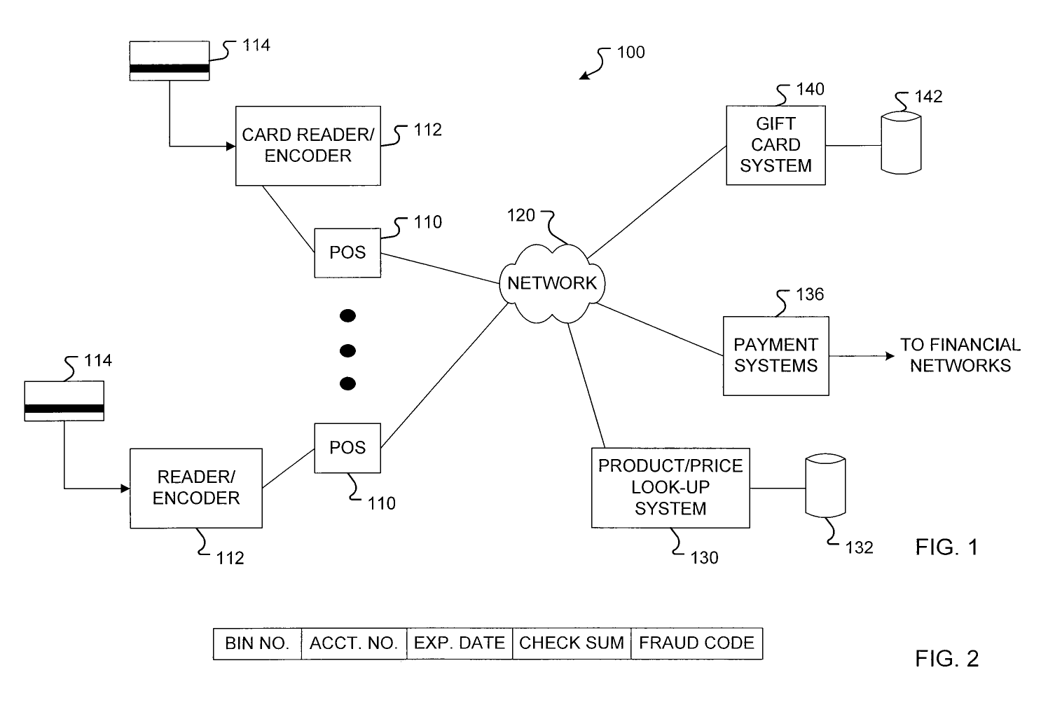

Referring now to FIG. 1, a network 100 according to one embodiment of the invention is illustrated. The network is used for both activating gift cards at a merchant location where the gift cards are purchased and permitting the cards to be used at a merchant location to make purchases or redemptions. The network includes a plurality of POS systems or terminals 110, each having an associated card reader/encoder 112 for reading a magnetic stripe on gift cards 114. The card reader/encoder 112 may also be used for writing data on the magnetic stripe of the cards 114, as will be more fully described later.

The POS terminals 110 are each connected through a network 120 (which may be public network such as the internet or, alternatively, a private retailer network) to a product/price look-up system 130 (having an associated database 132), to payment systems 136 (which are in turn connected to banking and financial networks), and to a gift card system 140 (having an associated database 142). Briefly, in operation, when a gift card is purchased at a merchant location and presented for purchase at a POS terminal, the card may be presented to a clerk who in turns reads the UPC (uniform product code) present on the card or its packaging, for a product and price look-up. The UPC code is sent to the product/price look-up system, which retrieves from database 132 the purchase price (and a product ID/description corresponding to the UPC code) and returns such data to the POS terminal. The clerk then accepts payment from the customer for the price of the gift card (in some cases, the customer may be able to select the price or amount to be loaded onto the gift card), and if the purchase is made by credit or debit card, such information is sent to the payment system 136 (and from there to the bank or financial institution maintaining the account from which payment is being made).

The clerk then swipes the gift card at the reader/encoder 112 so that a gift card/account number or identifier (ID) is read from the magnetic stripe on the card, and such ID number is sent to the gift card system 140, where the account is verified (such as through comparison to available account numbers stored in database 142). The account is then activated, such as through an activation code or marker bit set within database 142 for the account number or ID associated with the activated card or account.

When the customer who has purchased the gift card (or the recipient to whom it had been given by the customer) then presents the card for a purchase or redemption at a merchant location, the gift card 114 has its magnetic stripe again read at the card reader/encoder 112, so that the account associated with the card may be accessed at gift card system 140, and the account balance debited for the amount of the purchase/redemption.

The gift card network 100 as thus far described is conventional and is well know to those skilled in the art. A more detailed description of exemplary systems and processes used for activating and accessing gift card accounts can be found, for example, in U.S. patent application Ser. No. 11/122,414, filed May 4, 2005, for “System and Method for Accounting for Activation of Stored Value Cards,” by Dean A. Seifert et al., which is hereby incorporated by reference.

In accordance with embodiments of the invention, when the gift card 114 (and its associated gift card account) is activated at one of the POS terminals 112 (as a result of accessing gift card system 140 and its database 142), a fraud code is written onto the magnetic stripe of the card. In one embodiment, the fraud code may be a unique multi-bit code that is generated by gift card system 140 at the time the card is activated, and sent to POS terminal 110 so that it may be electronically written onto the magnetic stripe. That same fraud code may be stored within database 142 in association with the gift card account number, so that it may be retrieved when the gift card is used to make a purchase or redemption.

This is illustrated in FIG. 2, which shows exemplary data fields stored on the magnetic stripe of gift cards 114. As seen, the fields of data on the magnetic stripe include a BIN number (the merchant or financial institution that maintains the gift card account), an account number, an expiration date for the card, check sum digits (calculated from the other digits and used to make sure digits are correctly read at the POS terminal), and a fraud code. While the fraud code can be stored anywhere that space is available on the tracks of data on the magnetic stripe, in one embodiment the fraud code may be stored in the “additional data” or “discretionary data” sections of track one (such track is specified in the International Organization of Standardization standard ISO 7813).

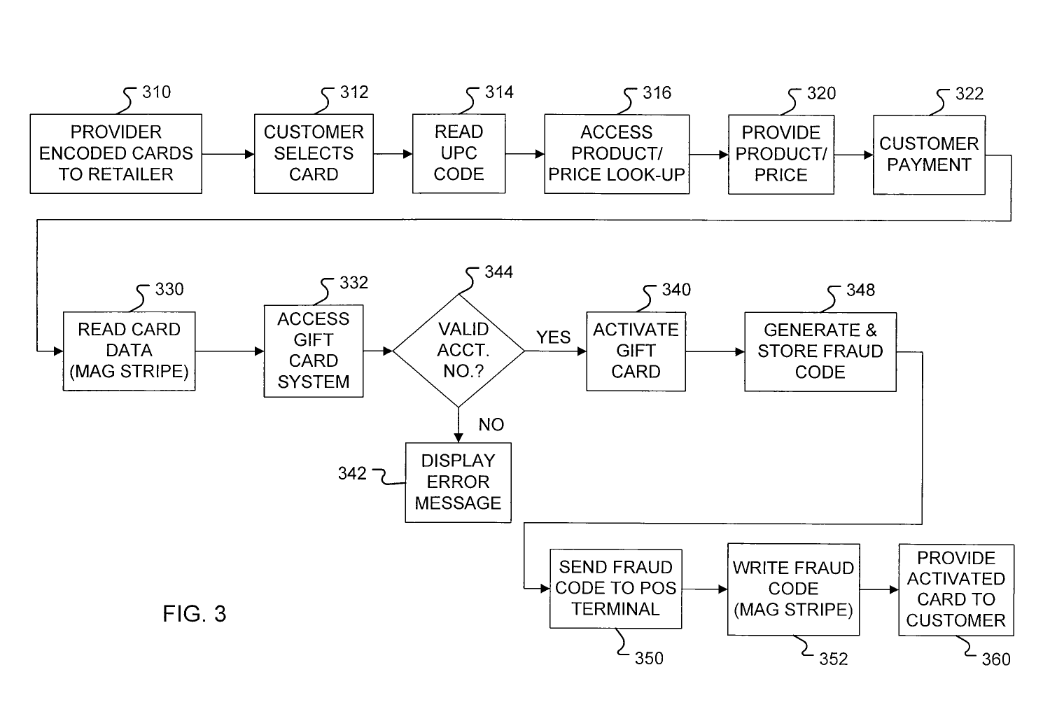

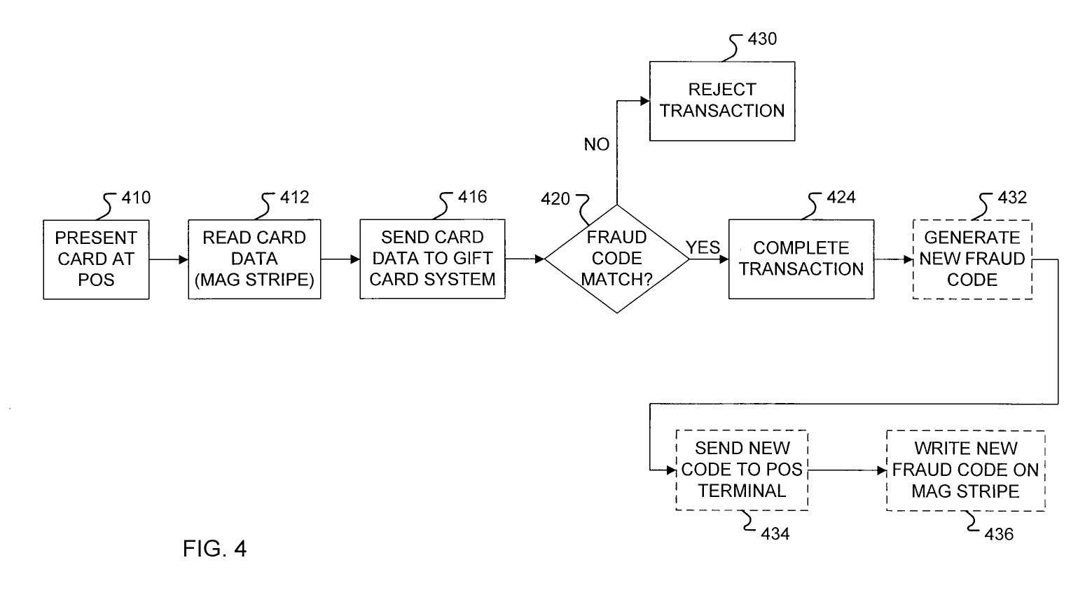

Programmed processes for carrying out one embodiment of the invention are illustrated in FIGS. 3 and 4. In FIG. 3, steps in a process for activating a gift card are seen. Initially, at step 310, encoded gift cards are provided to a merchant or retailer. The encoded information on the card comprises data written (at the time of manufacture or issuance) onto the magnetic stripe of the card in order for the card to be activated and used by the customer (such encoded data may be that seen in FIG. 2, but excluding a fraud code). The merchant will typically display the cards at a convenient location (e.g., near a check out station) for customers to see and then select for purchase (step 312). The card is presented to a clerk at a POS terminal, where a UPC or similar product code on the card (or on a sleeve or other card packaging) may be read (step 314) at an optical code scanner (not seen in the drawings) connected to the POS terminal. The POS terminal 110 accesses the product/price look-up system 130 (step 316) using the read UPC code, and the price and other product identifying information (card issuer and type, card face value, etc.) is retrieved from database 132 and returned to the POS terminal (step 320). The clerk then takes payment from the customer for the gift card (step 322). Such payment may be in the form of cash or may be a credit or debit card payment (authorized through payment systems 136).

Once the card has been purchased, it is activated by the clerk swiping the card through the magnetic stripe reader/encoder 112 in order to read (step 330) the card ID or gift account number encoded or stored on the magnetic stripe (FIG. 2), which is then used to access the gift card system 140 (and its database 142) at step 332. If the account number is determined to be valid (step 334), by matching it to account numbers stored in database 142, the account is activated at the system 140 (step 340). If the account number is not valid at step 334, an error message is returned and displayed at the POS terminal (step 342).

In one embodiment illustrated in FIG. 3, when the gift card account is activated, the gift card system creates a security or fraud code (step 348) and then sends that fraud code back to the POS terminal 112 (step 350). The fraud code can be generated in many possible ways. As examples only, the fraud code could be one or more bits that are randomly generated, or the fraud code could be generated with an algorithm employed at system 140 that uses, for example, the account number (as an input) and that provides (as an output) a unique multi-bit code. In these instances, the fraud code is also stored within database 142 at step 348 for later access (for purposes to be described below). In other embodiments, the fraud code could be generated at the POS terminal 110 (using algorithms stored at the terminal) with the generated fraud code subsequently sent to the gift card system 140 where it is stored in relation to the account number.

The reader/encoder 112 then writes the fraud code into the appropriate field on the magnetic stripe of the purchased gift card 114 (step 352). If using a conventional magnetic stripe writer/encoder device, this can be done by the clerk again swiping the card through the reader/encoder 112 (the same device used for reading the account number at step 330), when prompted at a display on the POS terminal. In some embodiments, the POS terminal could have two separate devices (one for reading at step 330 and one for writing at step 352). In yet other embodiments, the reader/encoder could be integrated with the POS terminal 110, in order to read (step 330) and write (step 352) as programmed into the POS terminal, for example, using a motorized drive after the card has been inserted into a card slot to automatically move the card past read and write heads at the appropriate points in time during the process.

After the fraud code has been written onto the magnetic stripe, the activated card is provided back to the customer, ready for use (step 360).

In FIG. 4, steps in a process for conducting transactions using a gift card 114 are seen. Initially, the gift card is presented to a clerk at one of the POS terminals 110 (step 410) as payment for a purchase or as part of a redemption. The clerk swipes the card at the reader/encoder 112, where the relevant card data (such as the data seen in FIG. 2) is read, including the fraud code (step 412). The read data is provided to the gift card system 140 (step 416), and is used to accesses the database 142. The data in database 142 is accessed not only to verify the validity of the account number (and the balance on the card), but also to determine if the fraud code data read from the card matches the fraud code stored in association with the account number in the database. If there is a match (step 420), the transaction continues to completion (step 424), with the account balance at database 142 adjusted as appropriate to reflect the transaction. If the fraud code in the database 142 does not match the fraud code data from the card at step 420 (e.g., resulting from the card having been “skimmed” by a thief), an error message is returned and displayed at the POS terminal (step 430).

As should be appreciated, the steps in the processes seen in FIGS. 3 and 4 are illustrative only, and some steps may be added or removed, and the order of steps changed. As one example only, and as illustrated in FIG. 4, the gift card system 140 may be programmed to generate a new, unique fraud code after each transaction is completed (step 432). The new code is sent to the POS terminal and written onto the magnetic stripe (steps 434, 436), after the transaction is completed. Such an arrangement might be implemented by the entity operating the gift card system, as a way of making it more difficult for a sophisticated thief to circumvent the fraud protection by trying different fraud codes, or by using a stolen gift card (after it has been activated) to analyze actual fraud codes in order to surreptitiously derive the algorithm used for generating fraud codes.

As should be appreciated, other embodiments are possible. For example, rather than storing the fraud code on a magnetic stripe, the fraud code could be stored in the memory of a smart card (i.e., a card having a processing/memory chip) or could be stored in memory associated with an RFID (radio frequency identification) device embedded on a card.

As another example, while the embodiments described above involve storing the fraud code at the gift card system 140, the fraud code could be generated at the POS terminal and/or matched at the POS terminal (using a fraud code generating/checking algorithm embedded or stored at the POS terminal). Further, while a fraud code unique to each gift card has been described, a less secure but perhaps less costly approach could involve placing the same fraud code on all cards at the merchant location upon activation.

Thus, while a detailed description of presently preferred embodiments of the invention has been given above, various other alternatives, modifications, and equivalents will be apparent to those skilled in the art without varying from the spirit of the invention. Therefore, the above description should not be taken as limiting the scope of the invention, which is defined by the appended claims.

1. A method for preventing fraudulent use of a stored value card, wherein the stored value card is a gift card, and wherein the gift card has a storage medium the method comprising:
storing an account identifier electronically in the storage medium;
at a POS terminal, activating the card for use in conducting transactions;
reading the storage medium at the POS terminal in order to retrieve the account identifier when the card is to be activated;
providing the account identifier to a gift card system;
generating a fraud code at the gift card system;
providing the fraud code to the POS terminal in order for the fraud code to be stored electronically in the storage medium on the gift card;
storing the fraud code electronically in the storage medium on the card at the POS terminal when the card is activated, so that the fraud code is not seen by a person in possession of the card; and
permitting a transaction to be completed using an activated card only if the fraud code is stored on the card.

2-5. (canceled)

6. The method of claim 1, wherein the POS terminal is at a merchant location.

7. The method of claim 6, wherein the storage medium is a magnetic stripe on the gift card, and wherein the POS terminal has a magnetic stripe reader for reading data from the magnetic stripe in order to retrieve the account identifier and a magnetic stripe encoder for storing the fraud code on the magnetic stripe.

8. The method of claim 6, wherein the storage medium is part of a chip embedded on the card.

9. The method of claim 6, wherein the storage medium is part of an RFID device embedded on the card.

10. The method of claim 1, wherein after generating the fraud code at the gift card system, the fraud code is stored in relation to the account identifier at a database associated with the gift card system.

11. The method of claim 1, wherein the fraud code is a multi-bit fraud code generated using an algorithm employed at the gift card system.

12. The method of claim 1, wherein the algorithm uses the account identifier as a data input to the algorithm.

13. A method for preventing fraudulent use of a stored value card, where the stored value card has a storage medium for storing an account identifier associated with the card, the method comprising:
reading the storage medium at an activating POS terminal when the card is being activated at a merchant location, in order to obtain the stored account identifier from the card, and thereby using the account identifier to activate the card for use in conducting transactions;
storing a separate fraud code on the storage medium of the card at the activating POS terminal when the card is activated;
reading the storage medium at a redemption POS terminal when the card is used for a transaction, in order to determine if the stored fraud code is present on the card, and permitting the transaction to be completed only if the fraud code is present; and
storing a new fraud code on the storage medium of the card at the redemption POS terminal after permitting the transaction to be completed, so that the new fraud code may be read when the card is used for a subsequent transaction.

14. The method of claim 13, wherein the stored value card is a gift card.

15. A system for preventing misuse of a stored value card purchased at a merchant location, where the card has a storage medium for holding an identifier associated with the card, and where the identifier is read from the storage medium in order for a cardholder to use the card to conduct a transaction, the system comprising:
a card reader at an activation terminal for reading the card identifier from the storage medium of the card when the card is to be activated at an activating merchant location; and
a card writer at the activation terminal for storing in the storage medium a fraud code that is separate from the card identifier when the card is activated for use at the activating merchant location, so that when the card is subsequently used by a card holder for a transaction at a redemption terminal at a redeeming merchant location, such transaction is permitted only if the fraud code is stored on the storage medium

16. The system of claim 15, wherein the stored value card is a gift card.

17. The system of claim 16, wherein the storage medium is a magnetic stripe on the gift card.

18. The system of claim 16, further comprising:
a gift card system for receiving the card identifier read when the card is to be activated; and
a database associated with the gift card system for storing the fraud code in relation to the card identifier.

19. The system of claim 18, further comprising an activating POS terminal at the activating merchant location having the card reader and the card writer.

20. The system of claim 18, further comprising a second card reader at the redeeming merchant location for reading both the card identifier and the fraud code from the storage medium on the card when the card is to be used for conducting a transaction, so that the card identifier and fraud code may be provided to the gift card system for comparing the fraud code read from the card to the fraud code stored in relation to the card identifier at the database.

21. The system of claim 18, wherein the gift card system generates the fraud code in response to receiving the card identifier.

22. The system of claim 21, wherein the gift card system receives the card identifier when the card is used for a transaction at the redemption terminal, wherein the gift card system generates a new fraud code in response to the card being used at the redemption terminal, and wherein the system further comprises a card writer at the redemption terminal for storing the new fraud code in the storage medium on the card.
